(19) United States
(12) Patent Application Publication
(10) Pub. No.: US 2020/0148150 A1
(43) Pub. Date: May 14, 2020

(54) BUBBLE PROTECTION IN OVERTURN

(71) Applicant: Continental Automotive Systems, Inc., Auburn Hills, MI (US)

(72) Inventor: Daniel Villarreal Rodriguez, Zapopan (MX)

(21) Appl. No.: 16/190,860

(22) Filed: Nov. 14, 2018

(51) Int. Cl. B60R 21/13; B62D 49/06; B60R 21/0132

(52) U.S. Cl. CPC B60R 21/131; B60R 2021/0018; B60R 21/0132; B62D 49/06

(57) ABSTRACT

The operator of a tractor is protected from injury or worse by deploying an air bag from the side of the tractor before the tractor's inclination angle relative to horizontal is less than a predetermined value below which the tractor will tip over.

### BACKGROUND

As used herein, the word “tractor” refers to a four-wheeled or tracked vehicle used especially for drawing farm equipment. Tractors are commonly used to pull implements that includes harvesters, tillage equipment, planters and the like.

It is well known that the weight of the tractor itself can cause the tractor and implements attached to it to overturn when the tractor is used on sloping terrain. When a tractor overturns, the operator can be severely injured or killed. An apparatus that would prevent or reduce the likelihood of injury to a tractor operator when the tractor overturns would be an improvement over the prior art.

### BRIEF DESCRIPTION OF THE FIGURES

FIG. 1 is a rear-end view of a tractor on sloping terrain and depicting its imminent overturning;

FIG. 2 depicts the rear-end view of a tractor and a bubble protector for a tractor operator when the tractor has overturned; and

FIG. 3 is a block diagram of an apparatus that prevents injury to a tractor operator when the tractor has tipped over.

### DETAILED DESCRIPTION

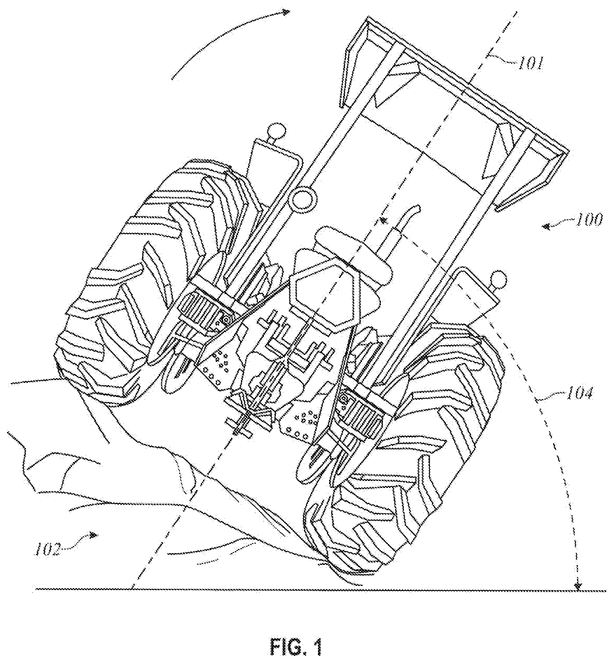

FIG. 1 is a rear end-view of a tractor 100 on a sloped terrain 102 and showing the tractor 100 inclined at an angle 104 relative to horizontal. It is well known that as the terrain 102 increases its elevation on the left-hand side of the tractor 100, the angle 104 will decrease. At some angle 104, determined in part by the tractor's size, its weight distribution and other factors, the tractor will tip over or overturn.

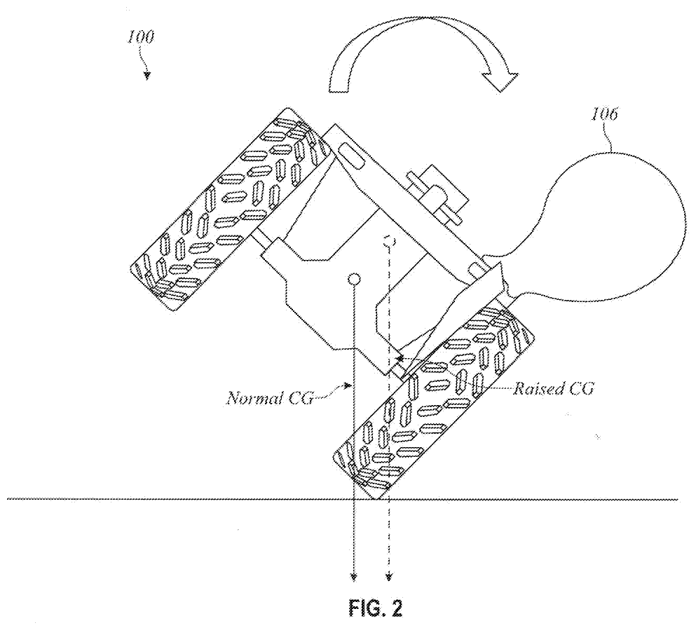

FIG. 2 shows the tractor 100 of FIG. 1 inclined at an angle below which the tractor is unstable and will tip over. An airbag 106, preferably made of a durable flexible rubber air bag is deployed in a fashion similar to how a conventional, prior art vehicle passenger compartment airbag is deployed except that the airbag 106 is deployed from the side of the tractor onto which it will roll thereby preventing the operator of the tractor from being injured. The air bag 106 is also deployed prior to when the tractor 100 begins to tip over. The air bag, which is considered as a bubble, protects the operator when the tractor overturns.

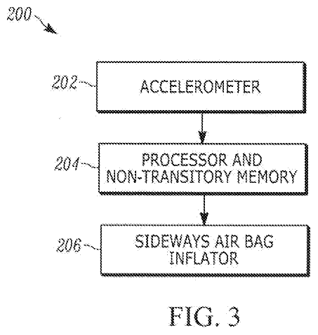

FIG. 3 depicts an apparatus 200 for the tractor 100, which protects the tractor operator (not shown) when the tractor 100 overturns. The apparatus is comprised of an accelerometer 202 which provides an output signal to a processor 204 that indicates the tractor's inclination angle relative to horizontal. The processor 204 executes program instructions stored in an associated non-transitory memory which cause the processor to generate a trigger signal to the sideways airbag inflator 206. As with prior art airbags commonly used in motor vehicles, the sideways airbag inflator 206 inflates the airbag 106 as shown in FIG. 2 and provides enough pressure to the airbag 106 to cushion the tractor and protect the operator when the tractor rolls over. Importantly and unlike prior art airbags that inflate on impact, the airbag 106 is inflated before the tractor 100 impacts the ground onto which it will land when it begins to tip over.

In a preferred embodiment, the airbag 106 is stored in a location on the tractor where it can be used to prevent injury regardless of the direction that the tractor might roll. In an alternate embodiment, a first airbag 106 is provided on the right hand side of the tractor and a second bag is provided on the left hand side of the tractor.

The foregoing description is for purposes of illustration only. The true scope of the invention is set forth in the following claims.

1. A tractor comprising:
an accelerometer, which is configured to generate an output signal that represents a sideways inclination angle of the tractor relative to horizontal
a processor coupled to the accelerometer and coupled to a non-transitory memory device that stores executable program instructions for the processor, said executable program instructions causing the processor to output a control signal to a linear actuator responsive to the processor's receipt of an output signal from the accelerometer that indicates that the tractor's inclination angle is less than a predetermined threshold value below which the tractor will tip over;
an air bag attached to a side of the tractor, operatively coupled to the processor and receiving a deployment signal from the processor; and
wherein the accelerometer provides a signal to the processor, which causes the processor to direct the air bag to inflate from the side of the tractor.

2. The tractor of claim 1, wherein the air bag is deployed prior to the inclination angle being less than a predetermined value.

3. The tractor of claim 1, wherein the linear actuator is hydraulic.

4. The tractor of claim 1, wherein the linear actuator comprises a rack and pinion.
